(19) United States
(12) Patent Application Publication
(10) Pub. No.: US 2008/0008786 A1
(43) Pub. Date: Jan. 10, 2008

(54) Edible Greeting Object for Pets

(76) Inventors: Arlene H. Sevilla, Milwaukee, WI (US); Maureen Hall, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/775,041

(22) Filed: Jul. 9, 2007

Related U.S. Application Data
(60) Provisional application No. 60/819,591, filed on Jul. 10, 2006.

(51) Int. Cl. A23L 1/38

(52) U.S. Cl. 426/87

(57) ABSTRACT

An edible greeting object for pets comprised of: an edible pet food component; a greeting component positioned on the edible pet food component; and a sealed packaging component substantially enclosing the edible pet food component and the greeting component. In one embodiment of the edible greeting object for pets, the edible pet food component includes approximately 1% to approximately 50% peanut butter.

### CROSS-REFERENCE TO RELATED APPLICATIONS

This application claims priority to U.S. Provisional patent application No. 60/819,591, filed on Jul. 10, 2006 and incorporated herein in its entirety.

### FIELD OF INVENTION

This invention relates generally to novelty items for animals, and more particularly to animal food items intended to convey greetings or messages to humans.

### BRIEF DESCRIPTION OF THE DRAWINGS

FIG. 1 is a top perspective view of one embodiment of the present invention.

FIG. 2 shows a cross-sectional side view of one embodiment of the edible greeting object for pets taken along line 2-2 of FIG. 1.

FIG. 3 shows a top perspective view of an alternate embodiment of the edible greeting object for pets.

### BACKGROUND

There is a substantial international market for pet gifts and pet related novelty items each year. It has been estimated that Americans spend more than $23 billion on pet related food and novelty items each year. Consumers often make point-of-purchase buying decisions triggered by a motivation or impulse to convey a sentiment, greeting or acknowledge and event or occasion. Pets are often trained, motivated or rewarded with food or consumable treats. It is desirable to have products available at a specific location or point in time, which makes it more likely that a consumer will notice the object, be amused by it and more likely to make a purchase decision. It is desirable to make greeting or novelty items accessible in venues where food products and perishable items may not be sold (for example, on card display racks shops, gift ships, stationary stores, online, etc). It is further desirable to have a pet food item which is easily modified to fit store displays (for example, a card or toy display or shelf or other type of display on which novelty consumer products are positioned within a store for consumer awareness) that is odorless and has a lengthy shelf life. It is also desirable that the object has an odor and flavor (such as beef, chicken, peanut butter, bacon or other food products) that appeals to a wide range of breeds and species of dogs, cats and other pets when the object is unsealed. Peanut butter is one example of a food odor and taste that is appealing to many breeds of dogs. However products containing it may emanate a distinctive odor and have a limited expiration date thus making it undesirable for sale in card shops, gift shops or other novelty item venues that do not routinely sell pet food products. Furthermore many pet food products contain oil beyond that needed to provide flavoring (e.g., oil beyond that found in peanut butter). The excess oil may cause staining and has excess undesireable calories for pets.

As used herein, “pet” refers to any domesticated animal or animal held in captivity by humans.

As used herein, “edible” refers to any substance which may be consumed or chewed by an animal and is not toxic to the animal.

As used herein, “greeting” refers to any text or image which conveys an image volume or has a connotation, including symbolizing a reward.

As used herein, “volume” refers to weight prior to cooking, drying or packaging of the food component and is determined at the time all ingredients have been added, but prior to drying, cooking or curing

As used herein, “edible adhesive” refers to any product which is non-toxic to a pet and serves to affix or adhere edible or non-edible objects together, including but not limited to egg whites, frosting and sugar paste.

As used herein, “edible ornamentation” includes any object or decoration (such as chips, candies, pet foods) which is non-toxic to a pet when ingested and which may be two- or three-dimensional.

### DETAILED DESCRIPTION OF EMBODIMENTS OF THE INVENTION

For the purpose of promoting an understanding of the present invention, references are made in the text hereof to embodiments of an edible greeting device for pets, only some of which are depicted in the figures. It should nevertheless be understood that no limitations on the scope of the invention are thereby intended. One of ordinary skill in the art will readily appreciate that modifications such as the size and shape of the embodiments, materials from which the embodiments are made, the packaging of the embodiments, the flavor, text images or message and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner.

It should be understood that the drawings are not necessarily to scale, emphasis instead being placed upon illustrating the principles of the invention. In addition, in the embodiments depicted herein, like reference numerals refer to like structural elements in the various drawings.

Moreover, the term “substantially” or “approximately” as used herein may be applied to modify any quantitative representation that could permissibly vary without resulting in a change in the basic function to which it is related. For example, one embodiment of an edible greeting object for pets may be rectangular in shape (e.g., like a gift card) while another embodiment may be shaped like an object, such as a bone. The shape, size, color and texture of the edible greeting object may vary and still be within the scope of the invention if its functionality is not materially altered.

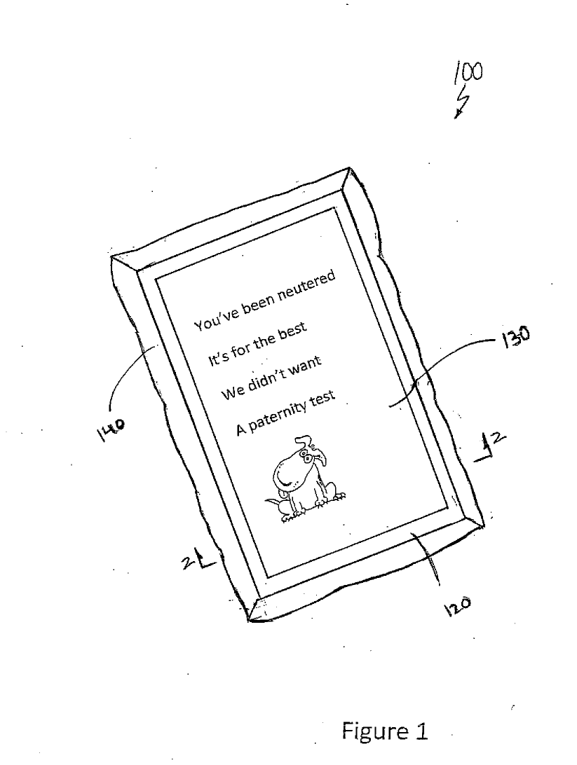

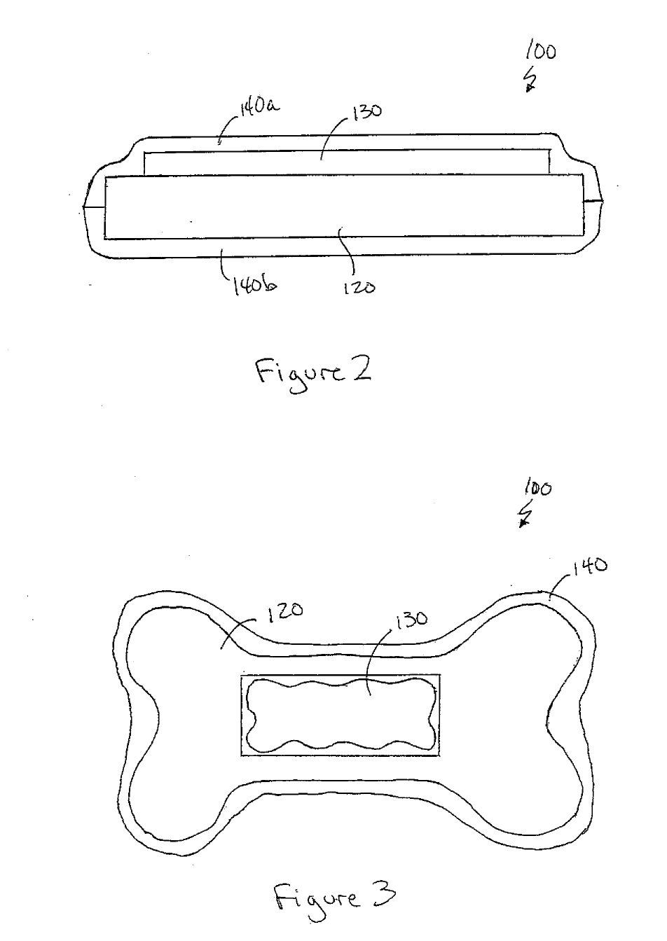

Referring now to the drawings, FIG. 1 shows a top perspective view of one embodiment of edible greeting object for pets 100. In the embodiment shown, edible greeting object for pets 100 is comprised of pet food component 120, greeting component 130 and packaging component 140. Packaging component 140 is comprised of packaging component top surface 140a and packaging component bottom surface 140b (described in detail infra with respect to FIG. 2). In the embodiment shown, greeting component 130 is made of an edible substance onto which food coloring or dye may be transferred to create text and images. The edible substance is easily molded into a variety of shapes, for example to resemble greeting card covers, book covers, diplomas, legal documents and certificates, objects such as dog bones, or human and animal shapes.

In the embodiment shown, greeting component 130 is affixed to pet food component 120 using a egg-white or other food substance which operates as an adhesive. However, greeting component 130 may include a dye or decorative edible or non-toxic material applied directly to pet food component 120. Both pet food component 120 and greeting component 130 are contained within package component 140 through which greeting component 130 may be viewed by a purchaser. In the embodiment of edible greeting object for pets 100 shown in FIG. 1, packaging component 140 is a substantially vacuum-sealed packaging in which top layer of packaging component 140a and bottom layer of packaging component 140b are substantially transparent. However, in other embodiments, one or both of top layer of packaging component 140a and bottom layer of packaging component 140b may be tinted, opaque or made of a substance other than decorative or non-decorative packaging sides and mold resistant and air-tight.

In the embodiment shown in FIG. 1, food component 120 is made of an edible substance, which includes any peanut butter, which is commercially available in sufficient quantity to be detected by a pet when packaging component 140 is removed. However, it should be understood that any alternate food substances having odor and taste appealing to pets, such as meat and fish products and artificial flavorings, can be included as ingredients or additives to food component 120. In one embodiment, food component 120 includes between approximately one percent (1%) and approximately fifty percent (50%) peanut butter.

FIG. 2 shows a cross-sectional side view of one embodiment of the edible greeting object for pets taken along line 2-2 of FIG. 1. FIG. 2 shows food component 130, top layer of packaging component 140a and bottom layer of packaging component 140b. In the embodiment shown, top layer of packaging component 140a and bottom layer of packaging component 140b are connected to form an airtight seal. However, in other embodiments, top layer of packaging component 140a and bottom layer of packaging component may be a single continuous sheath or enclosure, or may consist of multiple interconnected surfaces to form a packaging component 140. In other embodiments, packaging component 140 may consist entirely of an edible or non-edible protective coating.

FIG. 3 shows a top perspective view of an alternate embodiment of edible greeting object for pets 100. In this embodiment, edible greeting object for pets is in the shape of a bone.

While the edible greeting object for pets has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A device comprised of:
an edible pet food component;
a greeting component positioned on said edible pet food component; and
a sealed packaging component substantially enclosing said edible pet food component and said greeting component.

2. The device of claim 1, wherein said edible pet food component includes an ingredient selected from a group comprised of peanut butter, bacon, meat, fish products and artificial flavorings.

3. The device of claim 2, wherein said peanut butter is approximately one percent to approximately fifty percent of said edible pet food component by volume.

4. The device of claim 2, wherein said edible pet food component is prepared without the use of vegetable oil other than that which is contained within said peanut butter.

5. The device of claim 1, wherein said greeting component is affixed to said edible pet food component by an edible adhesive selected from a group comprised of egg white, frosting, or sugar paste.

6. The device of claim 1, wherein said greeting component is comprised of pigmentation applied to directly to said edible pet food component.

7. The device of claim 1, wherein said greeting component is comprised of edible ornamentation applied directly to said edible pet food component.

8. The device of claim 1, wherein said sealed packaging component is vacuum sealed to slow biological degradation of said edible pet food component.

9. A device comprised of:
an edible pet food component wherein said edible pet food component includes an ingredient selected from a group comprised of peanut butter, bacon, meat, fish products and artificial flavorings;
a greeting component positioned on said edible pet food component; and
a sealed packaging component substantially enclosing said edible pet food component and said greeting component.

10. The device of claim 9, wherein said peanut butter is approximately one percent to approximately fifty percent of said edible pet food component by volume.

11. The device of claim 9, wherein said edible pet food component is prepared without the use of vegetable oil other than that which is contained within said peanut butter.

12. The device of claim 9, wherein said greeting component is affixed to said edible pet food component by an edible adhesive selected from a group comprised of egg white, frosting, or sugar paste.

13. The device of claim 9, wherein said greeting component is comprised of pigmentation applied to directly to said edible pet food component.

14. The device of claim 9, wherein said greeting component is comprised of edible ornamentation applied directly to said edible pet food component.

15. The device of claim 9, wherein said sealed packaging component is vacuum sealed to slow biological degradation of said edible pet food component.

16. A device comprised of:
an edible pet food component wherein said edible pet food component comprises peanut butter between approximately one percent and approximately fifty percent of said edible pet food component by volume;
a greeting component positioned on said edible pet food component; and
a sealed packaging component substantially enclosing said edible pet food component and said greeting component.

17. The device of claim 16, wherein said edible pet food component is prepared without the use of vegetable oil other than that which is contained within said peanut butter.

18. The device of claim 16, wherein said greeting component is affixed to said edible pet food component by an edible adhesive selected from a group comprised of egg white, frosting, or sugar paste.

19. The device of claim 16, wherein said greeting component is comprised of edible ornamentation applied directly to said edible pet food component.

20. The device of claim 16, wherein said sealed packaging component is vacuum sealed to slow biological degradation of said edible pet food component.
